(19) United States
(12) Patent Application Publication
(10) Pub. No.: US 2010/0009261 A1
(43) Pub. Date: Jan. 14, 2010

(54) NEGATIVE ELECTRODE MATERIAL, MAKING METHOD, LITHIUM ION SECONDARY BATTERY, AND ELECTROCHEMICAL CAPACITOR

(76) Inventor: Koichiro WATANABE, Annaka-shi (JP)

Correspondence Address: BIRCH STEWART KOLASCH & BIRCH, PO BOX 747, FALLS CHURCH, VA, 22040-0747, US

(21) Appl. No.: 12/501,759

(22) Filed: Jul. 13, 2009

(30) Foreign Application Priority Data
Jul. 14, 2008 (JP) 2008-182636

(51) Int. Cl. H01M 4/48; B05D 5/12; H01G 9/042

(52) U.S. Cl. 429/231.8; 427/77; 361/500; 252/182.1

(57) ABSTRACT

Particles of a silicon oxide of formula: SiOx wherein x is 0.5 to 1.6, a silicon composite comprising silicon dispersed in silicon dioxide and having a molar ratio Si/O from 1:0.5 to 1:1.6, or a mixture thereof are doped with 50-100,000 ppm of phosphorus. A negative electrode material comprising the phosphorus-doped particles is suited for use in non-aqueous electrolyte secondary batteries. A lithium ion secondary battery having satisfactory cycle and rate properties is obtainable.

### CROSS-REFERENCE TO RELATED APPLICATION

This non-provisional application claims priority under 35 U.S.C. §119(a) on Patent Application No. 2008-182636 filed in Japan on Jul. 14, 2008, the entire contents of which are hereby incorporated by reference.

### TECHNICAL FIELD

This invention relates to non-aqueous electrolyte secondary batteries, typically lithium ion secondary batteries, and electrochemical capacitors. Specifically, it relates to a negative electrode material for use as an active material in such batteries which provides lithium ion secondary batteries with good cycle performance, and a method for preparing the same.

### BACKGROUND ART

With the recent rapid progress of potable electronic equipment and communication equipment, secondary batteries having a high energy density are strongly desired from the standpoints of economy and size and weight reduction. Prior art known attempts for increasing the capacity of such secondary batteries include the use as the negative electrode material of oxides of V, Si, B, Zr, Sn or the like or compound oxides thereof (JP-A 5-174818, JP-A 6-60867), melt quenched metal oxides (JP-A 10-294112), silicon oxide (Japanese Patent No. 2997741), and Si₂N₂O or Ge₂N₂O (JP-A 11-102705). Other known approaches taken for the purpose of imparting conductivity to the negative electrode material include mechanical alloying of SiO with graphite followed by carbonization (JP-A 2000-243396), coating of silicon particle surfaces with a carbon layer by chemical vapor deposition (JP-A 2000-215887), and coating of silicon oxide particle surfaces with a carbon layer by chemical vapor deposition (JP-A 2002-42806).

These prior art methods are successful in increasing the charge/discharge capacity and the energy density of secondary batteries, but fall short of the market demand partially because of unsatisfactory cycle performance. There is a demand for further improvement in energy density.

More particularly, Japanese Patent No. 2997741 describes a high capacity electrode using silicon oxide as the negative electrode material in a lithium ion secondary cell. As long as the present inventors have empirically confirmed, the performance of this cell is yet unsatisfactory due to an increased irreversible capacity on the first charge/discharge cycle and a practically unacceptable level of cycle performance. With respect to the technique of imparting conductivity to the negative electrode material, JP-A 2000-243396 provides insufficient conductivity since a uniform carbon coating is not formed due to solid-solid fusion. JP-A 2000-215887 is successful in forming a uniform carbon coating, but the negative electrode material based on silicon experiences extraordinary expansion and contraction upon absorption and desorption of lithium ions and as a result, fails to withstand practical service. At the same time, the cycle performance declines, and the charge/discharge quantity must be limited in order to prevent such decline. In JP-A 2002-42806, an improvement in cycle performance is ascertainable, but the capacity gradually decreases with the repetition of charge/discharge cycles and suddenly drops after a certain number of cycles, because of precipitation of silicon crystallites, the under-developed structure of the carbon coating and insufficient fusion of the carbon coating to the substrate. This negative electrode material is yet insufficient for use in secondary batteries.

Citation List

Patent Document 1: JP-A 5-174818

Patent Document 2: JP-A 6-60867

Patent Document 3: JP-A 10-294112

Patent Document 4: JP 2997741

Patent Document 5: JP-A 11-102705

Patent Document 6: JP-A 2000-243396

Patent Document 7: JP-A 2000-215887

Patent Document 8: JP-A 2002-42806

Patent Document 9: U.S. Pat. No. 7,037,581 (JP 3952180)

### SUMMARY OF THE INVENTION

An object of the invention is to provide a negative electrode material to form a negative electrode for use in non-aqueous electrolyte secondary batteries, especially lithium ion secondary batteries, which provides them with better cycle and rate properties, and a method for preparing the same. Another object is to provide a lithium ion secondary battery and an electrochemical capacitor using the same.

The inventor has found that when phosphorus-doped particles in which a silicon oxide of the general formula: SiOx wherein x is 0.5 to 1.6, a silicon composite comprising silicon dispersed in silicon dioxide and having a molar ratio Si/O from 1:0.5 to 1:1.6, or a mixture thereof is doped with 50 to 100,000 ppm of phosphorus are used as a negative electrode material for non-aqueous electrolyte secondary batteries, improvements in rate and cycle properties are observed due to improved bulk conductivity. The present invention is predicated on this finding.

In one aspect, the invention provides a negative electrode material for non-aqueous electrolyte secondary batteries, comprising phosphorus-doped particles of a silicon oxide of the general formula: SiOx wherein x has a value of 0.5 to 1.6, a silicon composite comprising silicon dispersed in silicon dioxide and having a molar ratio of Si/O from 1:0.5 to 1:1.6, or a mixture thereof which is doped with phosphorus in an amount of 50 to 100,000 ppm.

Typically, phosphorus has been doped using POCl₃. In a preferred embodiment, the phosphorus-doped particles are coated on their surface with a carbon coating.

In another aspect, the invention provides a method for preparing the negative electrode material defined above, comprising doping a silicon oxide of the general formula: SiOx wherein x has a value of 0.5 to 1.6, a silicon composite comprising silicon dispersed in silicon dioxide and having a molar ratio of Si/O from 1:0.5 to 1:1.6, or a mixture thereof with phosphorus.

Typically, the doping step includes treating the silicon oxide, silicon composite or mixture thereof with POCl₃ at a temperature of 500 to 1,200° C.

The invention also provides a method for preparing the negative electrode material defined above, comprising the steps of:

(I) treating a silicon oxide of the general formula: SiOx wherein x has a value of 0.5 to 1.6, a silicon composite comprising silicon dispersed in silicon dioxide and having a molar ratio of Si/O from 1:0.5 to 1:1.6, or a mixture thereof with POCl₃ at a temperature of 500 to 1,200° C. for phosphorus doping to form phosphorus-doped particles, and

(II) effecting chemical vapor deposition on the phosphorus-doped particles of step (I) in an organic gas and preferably under a reduced pressure of up to 30,000 Pa, thereby coating the phosphorus-doped particles on their surface with a carbon coating.

Further embodiments of the invention include a lithium ion secondary battery and an electrochemical capacitor, comprising the negative electrode material defined above.

### ADVANTAGEOUS EFFECTS OF INVENTION

Using the phosphorus-doped particles as a negative electrode material, a lithium ion secondary battery can be constructed which is improved in rate and cycle properties. The method of preparing the phosphorus-doped particles is simple and amenable to production on a commercial mass scale.

### DESCRIPTION OF EMBODIMENTS

As used herein, the term “conductive” or “conductivity” refers to electrically conductive or electric conductivity.

The negative electrode material for non-aqueous electrolyte secondary batteries according to the invention is defined as comprising phosphorus-doped particles which are obtained by doping a silicon oxide of the general formula: SiOx wherein x is a number of 0.5 to 1.6, a silicon composite comprising silicon dispersed in silicon dioxide and having a molar ratio Si/O from 1:0.5 to 1:1.6, or a mixture thereof with phosphorus.

### Silicon Oxide, Silicon Composite

As used herein, the “silicon oxide” generally refers to amorphous silicon oxides obtained by heating a mixture of silicon dioxide and metallic silicon to produce a silicon monoxide gas and cooling the gas for precipitation. The silicon oxide used herein is represented by the general formula: SiOx wherein x is a number from 0.5 to 1.6. The “silicon composite” refers to a composite material of the structure in which silicon is dispersed in silicon dioxide and having a molar ratio of Si/O from 1:0.5 to 1:1.6. Both the value of x and the molar ratio O/Si are in the range from 0.5 to 1.6, preferably from 0.8 to 1.3, and more preferably from 0.8 to 1.2. It is difficult to prepare a silicon oxide or silicon composite in which the value of x or O/Si is less than 0.5. If the value of x or O/Si is in excess of 1.6, heat treatment for disproportionation reaction may lead to a higher proportion of inert SiO₂, which may cause a reduction of charge/discharge capacity when incorporated in a lithium ion secondary battery.

Particles of the silicon oxide or silicon composite should preferably have a volume average particle size D₅₀ of 0.01 to 50 μm, and more preferably 0.1 to 10 μm.

It is noted that the volume average particle size D₅₀ is determined as a particle diameter or median diameter at which the cumulative volume reaches 50% in a particle size distribution measured by the laser diffraction scattering method. Particles with an average particle size D₅₀ of less than 0.01 μm may have a lower purity due to the influence of surface oxidation, and when used as the negative electrode material in a lithium ion secondary battery, may suffer from a reduction of charge/discharge capacity and a lowering of bulk density, and hence, a reduction of charge/discharge capacity per unit volume. Particles with an average particle size D₅₀ of more than 50 μm may penetrate through a negative electrode film, causing short-circuits.

The silicon composite may be produced, for example, by the method of U.S. Pat. No. 7,037,581 (JP 3952180). Also the silicon composite of the structure in which silicon is dispersed in silicon dioxide is characterized in that on analysis by x-ray diffraction (Cu-Kα) using copper as the counter cathode, a diffraction peak attributable to Si(111) is observed as centering near 2θ=28.4°. Preferably the silicon composite satisfies the following characteristics.

(i) On analysis by x-ray diffraction (Cu-Kα) using copper as the counter cathode, a diffraction peak attributable to Si(111) is observed as centering near 2θ=28.4°, and the silicon crystallites have a grain size of 1 to 500 nm, more preferably 2 to 200 nm, even more preferably 2 to 50 nm as determined by Scherrer equation based on the spread of the diffraction peak. If silicon crystallites have a grain size of less than 1 nm, a reduction of charge/discharge capacity may be observed. If the grain size is more than 500 nm, substantial expansion and contraction may occur upon charge/discharge cycles, leading to a decline of cycle performance. It is noted that the size of silicon crystallites is measured by transmission electron microscope (TEM) photomicrography.

(ii) On analysis by solid-state NMR (²⁹Si-DDMAS), a broad peak of silicon dioxide centering at approximately −110 ppm and a peak characteristic of Si diamond crystals near −84 ppm appear in the spectrum. It is noted that this spectrum is entirely different from that of ordinary silicon oxide (SiOx wherein x=1.0+α), indicating that the structure itself apparently differs from the latter. It is confirmed by observation under TEM that silicon crystals are dispersed in amorphous silicon dioxide.

While the negative electrode material for non-aqueous electrolyte secondary batteries is defined as comprising phosphorus-doped particles, the phosphorus-doped particles may be obtained by doping a silicon oxide of the general formula: SiOx wherein x has a value of 0.5 to 1.6, a silicon composite comprising silicon dispersed in silicon dioxide and having a molar ratio of Si/O from 1:0.5 to 1:1.6, or a mixture thereof with phosphorus through treatment with a suitable phosphorus compound. Typically phosphorus doping is achieved by treatment with POCl₃ at a temperature of 500 to 1,200° C., and specifically, by admixing the silicon oxide, silicon composite or mixture thereof with POCl₃ and heat treating at a temperature of 500 to 1,200° C. Heat treatment is preferably performed at a temperature of 800 to 1,200° C., and more preferably 800 to 900° C., and preferably in an inert gas atmosphere, typically argon gas. A treating temperature below 500° C. may lead to a less doping. Inversely, a treating temperature above 1,200° C. may consolidate the structure of silicon dioxide moiety to obstruct movement of lithium ions, leading to a degradation of the function as lithium ion secondary battery.

The treating time may be selected as appropriate depending on the desired doping level and treating temperature, although a time of 1 to 10 hours, especially 2 to 5 hours is usually cost effective.

The doping amount of phosphorus is 50 to 100,000 ppm, and preferably 100 to 10,000 ppm, based on the weight of phosphorus-doped particles. Less than 50 ppm of phosphorus may lead to short rate property whereas more than 100,000 ppm of phosphorus may lead to a capacity decline.

In a preferred embodiment of the negative electrode material for non-aqueous electrolyte secondary batteries, the phosphorus-doped particles are coated on their surface with a carbon coating to endow the particles with conductivity. The coating step is preferably carried out by effecting chemical vapor deposition (CVD) on the phosphorus-doped particles in an organic gas. This may be efficiently done by introducing the organic gas into the reactor during heat treatment.

Specifically, CVD is effected on phosphorus-doped particles in an organic matter gas under a reduced pressure of up to 30,000 Pa. The pressure is preferably up to 10,000 Pa, and more preferably 2,000 Pa. If the reduced pressure is higher than 30,000 Pa, the coating may contain a more proportion of a graphitic material of graphite structure, leading to a reduction of battery capacity and a lowering of cycle performance when used as a lithium ion secondary battery negative electrode material. The CVD temperature is preferably 800 to 1,200° C. and more preferably 900 to 1,100° C. A temperature below 800° C. may require a longer time of treatment. Inversely, if the treating temperature is above 1,200° C., particles may fuse and agglomerate together during CVD, avoiding formation of a conductive coating at the agglomerated interface and resulting in a negative electrode material having poor cycle performance when used in a lithium ion secondary battery. The treating time may be selected as appropriate depending on the desired graphite coverage, treating temperature, the concentration, flow rate and feed amount of organic gas although a time of 1 to 10 hours, especially 2 to 7 hours is usually cost effective.

In the practice of the invention, the organic material to generate the organic gas is selected from those materials capable of producing carbon (graphite) through pyrolysis at the heat treatment temperature, especially in a non-oxidizing atmosphere. Exemplary are hydrocarbons such as methane, ethane, ethylene, acetylene, propane, butane, butene, pentane, isobutane, and hexane alone or in admixture of any, and monocyclic to tricyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene alone or in admixture of any. Also, gas light oil, creosote oil and anthracene oil obtained from the tar distillation step are useful as well as naphtha cracked tar oil, alone or in admixture.

Preferably, the amount of carbon coated or deposited on particles, simply referred to as “carbon coverage,” is 0.3 to 40% by weight and more preferably 0.5 to 30% by weight based on the weight of the carbon-coated, phosphorus-doped particles. With a carbon coverage of less than 0.3% by weight, the powder may be less conductive and provide unsatisfactory cycle performance when used as the negative electrode material in a non-aqueous electrolyte secondary battery. A carbon coverage of more than 40% by weight may achieve no further effect and indicates a too high graphite content in the negative electrode material, which may reduce the charge/discharge capacity when used as the negative electrode material in a non-aqueous electrolyte secondary battery.

### P-Doped Particles

The phosphorus-doped particles are formed of a silicon oxide of formula: SiOx wherein x=0.5 to 1.6, a silicon composite comprising silicon dispersed in silicon dioxide and having a molar ratio Si/O from 1:0.5 to 1:1.6, or a mixture thereof which is doped with phosphorus in an amount of 50 to 100,000 ppm. Both the value of x and the molar ratio O/Si are in the range from 0.5 to 1.6, preferably from 0.8 to 1.3, and more preferably from 0.8 to 1.2. The phosphorus-doped particles preferably have a volume average particle size D₅₀ of 0.01 to 50 μm, and more preferably 0.1 to 10 μm (the average particle size D₅₀ being as defined above). In the embodiment wherein the base is a silicon composite, it should preferably meet the aforementioned characteristics (i) and (ii).

### Negative Electrode Material

According to the invention, the phosphorus-doped particles may be used as a negative electrode material to construct a non-aqueous electrolyte secondary battery, especially a lithium ion secondary battery. The invention provides a negative electrode material for non-aqueous electrolyte secondary batteries, comprising the phosphorus-doped particles. Using this negative electrode material to form a negative electrode, a lithium ion secondary battery may be constructed.

When a negative electrode is prepared using the negative electrode material, a conductive agent such as carbon or graphite may be added to the negative electrode material. The type of conductive agent used herein is not particularly limited as long as it is an electronically conductive material which does not undergo decomposition or alteration in the battery. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins.

The negative electrode may be prepared, for example, as a shaped body by the following method. The phosphorus-doped particles and optional additives such as a conductive agent and binder are kneaded in a solvent such as N-methylpyrrolidone or water to form a paste mix, which is applied to a sheet as a current collector. The current collector used herein may be of any materials commonly used as the negative electrode current collector such as copper and nickel foils while it is not particularly limited in thickness and surface treatment. The technique of shaping the mix into a sheet is not particularly limited and any well-known techniques may be used.

### Lithium Ion Secondary Battery

The lithium ion secondary battery is characterized by the use of the negative electrode material while the materials of the positive electrode, negative electrode, electrolyte, and separator and the battery design may be well-known ones and are not particularly limited. For example, the positive electrode active material used herein may be selected from transition metal oxides such as LiCoO₂, LiNiO₂, LiMn₂O₄, V₂O₅, MnO₂, TiS₂ and MOS₂, lithium, and chalcogen compounds. The electrolytes used herein may be lithium salts such as lithium hexafluorophosphate and lithium perchlorate in non-aqueous solution form. Examples of the non-aqueous solvent include propylene carbonate, ethylene carbonate, diethyl carbonate, dimethoxyethane, γ-butyrolactone and 2-methyltetrahydrofuran, alone or in admixture. Use may also be made of other various non-aqueous electrolytes and solid electrolytes.

### Electrochemical Capacitor

A further embodiment is an electrochemical capacitor which is characterized by comprising the negative electrode material described above, while other materials such as electrolyte and separator and capacitor design are not particularly limited. Examples of the electrolyte used include non-aqueous solutions of lithium salts such as lithium hexafluorophosphate, lithium perchlorate, lithium borofluoride, and lithium hexafluoroarsenate, and exemplary non-aqueous solvents include propylene carbonate, ethylene carbonate, dimethyl carbonate, diethyl carbonate, dimethoxyethane, γ-butyrolactone, and 2-methyltetrahydrofuran, alone or a combination of two or more. Other various non-aqueous electrolytes and solid electrolytes may also be used.

### EXAMPLE

Examples of the invention are given below by way of illustration and not by way of limitation.

### Example 1

A batchwise heating furnace was charged with 100 g of a silicon composite powder having a molar ratio Si/O of 1/1.02 and an average particle size of 5 μm. A temperature distribution throughout the furnace was monitored, such that 2.5 g of POCl₃ was placed at the position which would reach 200° C. when the location of the silicon composite powder reached 900° C. The furnace was purged with Ar gas, and after a shutoff of Ar feed, heated to 900° C. at a ramp of 300° C./hr and held at 900° C. for 3 hours. The furnace was again heated to 1,100° C. while it was evacuated by means of an oil sealed rotary vacuum pump. Once the furnace reached a temperature of 1,100° C. and a reduced pressure below 100 Pa, CH₄ gas was fed at 0.5 NL/min, and graphite coating treatment was carried out for 5 hours. A reduced pressure of 800 Pa was kept during the treatment. At the end of treatment, the furnace was cooled down, obtaining about 105 g of a black powder. The black powder was a conductive powder having an average particle size of 5.2 Km and a graphite coverage of 4.9% by weight based on the black powder. The P content of the powder was analyzed by ICP, finding 1,500 ppm of phosphorus.

### Cell Test

A cell using the conductive powder as a negative electrode material was evaluated by the following test. First 10 wt % of polyimide was added to 90 wt % of the conductive powder obtained above and N-methylpyrrolidone added to form a slurry. The slurry was coated onto a copper foil of 20 μm gage and dried at 80° C. for one hour. Using a roller press, the coated foil was shaped under pressure into an electrode sheet. The electrode sheet was vacuum dried at 350° C. for 1 hour, after which 2 cm² discs were punched out as the negative electrode.

To evaluate the charge/discharge properties of the negative electrode, a test lithium ion secondary cell was constructed using a lithium foil as the counter electrode. The electrolyte solution used was a non-aqueous electrolyte solution of lithium hexafluorophosphate in a 1/1 (by volume) mixture of ethylene carbonate and diethyl carbonate in a concentration of 1 mol/liter. The separator used was a microporous polyethylene film of 30 μm thick.

The lithium ion secondary cell thus constructed was allowed to stand overnight at room temperature. Using a secondary cell charge/discharge tester (Nagano K.K.), a charge/discharge test was carried out on the cell. Charging was conducted with a constant current flow of 0.5 mA/cm² until the voltage of the test cell reached 0 V, and after reaching 0 V, continued with a reduced current flow so that the cell voltage was kept at 0 V, and terminated when the current flow decreased below 40 μA/cm². Discharging was conducted with a constant current flow of 0.5 mA/cm² and terminated when the cell voltage rose above 2.0 V, from which a discharge capacity was determined.

By repeating the above operation, the charge/discharge test was carried out 200 cycles on the lithium ion secondary cell. The cell showed a capacity retentivity of 86% after 200 cycles. It was a lithium ion secondary cell having improved cycle performance.

In the cell, discharging was conducted at rates 0.2 C and 1.0 C. Provided that the discharge capacity at 1.0 C discharging divided by discharge capacity at 0.2 C discharging represents a rate factor (%), the cell showed a rate factor of 90%. It was a lithium ion secondary cell having superior rate property.

### Example 2

By following the procedure of Example 1 aside from using 1.0 g of POCl₃, about 105 g of a conductive powder was obtained. The conductive powder had an average particle size of 5.1 μm and a graphite coverage of 5.1% by weight based on the black powder. The powder had a P content of 400 ppm.

### Comparative Example 1

The procedure was the same as in Example 1 except that the batchwise heating furnace was charged solely with 100 g of the silicon composite powder (in Example 1), the presence of POCl₃ when the powder temperature reached 900° C. was canceled, and graphite coating treatment was directly effected at 1,100° C. About 104 g of a conductive powder was obtained. The conductive powder had an average particle size of 5.2 μm and a graphite coverage of 4.8% by weight. The powder contained 12 ppm of phosphorus, which originated from the starting material.

### Comparative Example 2

The procedure was the same as in Example 1 except that the batchwise heating furnace was charged with 100 g of the silicon composite powder (in Example 1) and heated to 1,100° C., whereupon an argon gas containing 2 ppm of PH₃ was fed at 3.0 L/min for 3 hours. Thereafter, graphite coating treatment was similarly effected. About 105 g of a conductive powder was obtained. The conductive powder had an average particle size of 5.2 μm and a graphite coverage of 5.0% by weight. The powder had a P content of 31 ppm.

Using these conductive powders, test cells were fabricated. The same cell test as above was carried out, with the results shown in Table 1.

TABLE 1

| | P content, | Capacity retentivity | 1.0 C/ |
|---|---|---|---|
| | ppm | after 200 cycles, % | 0.2 C, % |
| Example 1 | 1500 | 86 | 90 |
| Example 2 | 400 | 83 | 87 |
| Comparative | 12 | 75 | 80 |
| Example 1 | | | |
| Comparative | 31 | 77 | 82 |
| Example 2 | | | |

On analysis of the silicon composite and black powders in Examples 1 and 2 by x-ray diffraction (Cu-Kα) using copper as the counter cathode, a diffraction peak attributable to Si(111) was observed as centering near 2θ=28.4°, confirming the structure that silicon was dispersed in silicon dioxide.

Japanese Patent Application No. 2008-182636 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A negative electrode material for non-aqueous electrolyte secondary batteries, comprising phosphorus-doped particles of a silicon oxide of the general formula: SiOx wherein x is 0.5 to 1.6, a silicon composite comprising silicon dispersed in silicon dioxide and having a molar ratio of Si/O from 1:0.5 to 1:1.6, or a mixture thereof, which is doped with phosphorus in an amount of 50 to 100,000 ppm.

2. The negative electrode material of claim 1 wherein phosphorus has been doped using POCl₃.

3. The negative electrode material of claim 1 wherein the phosphorus-doped particles are coated on their surface with a carbon coating.

4. A method for preparing the negative electrode material of claim 1, comprising doping a silicon oxide of the general formula: SiOx wherein x is 0.5 to 1.6, a silicon composite comprising silicon dispersed in silicon dioxide and having a molar ratio of Si/O from 1:0.5 to 1:1.6, or a mixture thereof with phosphorus.

5. The method of claim 4 wherein the doping step includes treating the silicon oxide, silicon composite or mixture thereof with POCl₃ at a temperature of 500 to 1,200° C.

6. A method for preparing the negative electrode material of claim 3, comprising the steps of:
(I) treating a silicon oxide of the general formula: SiOx wherein x is 0.5 to 1.6, a silicon composite comprising silicon dispersed in silicon dioxide and having a molar ratio of Si/O from 1:0.5 to 1:1.6, or a mixture thereof with POCl₃ at a temperature of 500 to 1,200° C. for phosphorus doping to form phosphorus-doped particles, and
(II) effecting chemical vapor deposition on the phosphorus-doped particles of step (I) in an organic gas, thereby coating the phosphorus-doped particles on their surface with a carbon coating.

7. The method of claim 6 wherein step (II) is effected under a reduced pressure of up to 30,000 Pa.

8. A lithium ion secondary battery comprising the negative electrode material of claim 1.

9. An electrochemical capacitor comprising the negative electrode material of claim 1.
